(19) United States
(12) Patent Application Publication
(10) Pub. No.: US 2009/0004054 A1
(43) Pub. Date: Jan. 1, 2009

(54) PERSONAL BREATHALYZER

(76) Inventors: Paul C. Burke, Lake Forest, IL (US); Wong Chi Wing, Hong Kong (CN)

Correspondence Address: PATZIK, FRANK & SAMOTNY LTD., 150 SOUTH WACKER DRIVE, SUITE 1500, CHICAGO, IL, 60606, US

(21) Appl. No.: 11/382,197

(22) Filed: May 8, 2006

(51) Int. Cl. G01N 31/22

(52) U.S. Cl. 422/58

(57) ABSTRACT

The present invention relates to a portable, personal breath tester device for testing the blood alcohol content of the user of the device. The breath tester includes an electronic sensor for providing an output voltage signal with an amplitude level that varies as a function of the alcohol content of the breath sample. The output voltage signal is coupled as an input signal to analog circuitry for comparing the input signal to predefined voltage thresholds associated with known blood alcohol contents. The analog circuitry generates an output signal to a display comprising a first and second LED, wherein the illumination of a specific LED corresponds to a predefined blood alcohol content range.

### FIELD OF THE INVENTION

The present invention relates to gaseous breath detection devices, and methods for using the same, and more particularly to a portable personal gaseous breath detection device incorporating analog circuitry to analyze a breath sample from the user of device for the presence of alcohol.

### BACKGROUND OF INVENTION

The present invention relates generally to devices and methods for determining the concentration of alcohol in a mixture of gases and more particularly, the invention relates to a device and method for determining the concentration of alcohol in a breath sample for application in sobriety detection systems.

Various techniques have been employed for calculating a person's blood alcohol concentration by measuring breath samples. A first method employs an infrared absorption technique for determining the blood alcohol concentration. Breath alcohol levels are measured by passing a narrow band of IR light, selected for its absorption by alcohol, through one side of a breath sample chamber and detecting emergent light on the other side. The alcohol concentration is then determined by using the well-known Lambert-Beers law, which defines the relationship between concentration and IR absorption. This IR technology has the advantage of making real-time measurements; however, it is particularly difficult and expensive to achieve specificity and accuracy at low breath alcohol concentration levels. Also, the IR detector output is nonlinear with respect to alcohol concentration and must be corrected by measurement circuits.

A second method employs a fuel cell together with an electronic circuit. In breath alcohol testing devices presently used commercially, in which fuel cells are employed, the conventional way of determining breath alcohol is to measure a peak voltage across a resistor due to the flow of electrons obtained from the oxidation of breath alcohol on the surface of the fuel cell. Although this method has proven to have high accuracy levels, there are a number of problems. The peaks become lower with repeated use of the fuel cell and vary with different temperatures. In order to produce a high peak, it is customary to put across the output terminals of the fuel cell a high external resistance, on the order of a thousand ohms, but the use of such a high resistance produces a voltage curve which goes to the peak and remains on a high plateau for an unacceptably long time. To overcome that problem, fuel cell systems began to short the terminals, which drops the voltage to zero while the short is across the terminals. However, it is still necessary to let the cell recover, because if the short is removed in less than one-half to two minutes after the initial peak time, for example, the voltage creeps up. Peak values for the same concentration of alcohol decline with repeated use whether the terminals are shorted or not, and require 15-25 hours to recover to their original values.

In addition, individual fuel cells differ in their characteristics. All of them slump with repeated use in quick succession and also after a few hours' time of non-use. They degrade over time, and in the systems used heretofore, must be re-calibrated frequently. Eventually, they degrade to the place at which they must be replaced. Presently, the cell is replaced when it peaks too slowly or when the output at the peak declines beyond practical re-calibration, or when the background voltage begins creeping excessively after the short is removed from the cell terminals.

Systems employing this method were also cost prohibitive for many applications. One reason for the high cost associated with the fuel cell techniques is that the method requires that the breath sample be of a determinable volume. Historically, this has been accomplished through the use of positive displacement components such as piston-cylinder or diaphragm mechanisms. The incorporation of such components within an electronic device necessarily increases the costs associated with the device.

In a third method, the alcohol content in a breath sample is measured using a semiconductor sensor commonly referred to as a Tagucci cell. Among the advantages of devices utilizing semiconductor sensors are simplicity of use, lightweight, and ease of portability and storage. Such units have been employed in law enforcement work as “screening units,” to provide preliminary indications of a blood alcohol content and for personal use. Although this method provides a low cost device, instruments incorporating this method have proved to have poor accuracy because of the need to hold input voltage signals to the electronic components of the device at constant, steady, regulated levels.

Accordingly, it is desirable to have a breath test device that is easy to use yet accurate in its results, is portable and is an item that the user will remember to bring with him/her to an event or location where alcohol is being consumed.

### SUMMARY OF THE INVENTION

The present invention provides in one embodiment an electronic breath analyzer. The analyzer includes a gas sensor for alcohol detection. The gas sensor having a heater and a gas sensing element. The analyzer further includes a regulated voltage circuit having an operation amplifier, the op-amp having a negative input coupled to the voltage source, a positive input and an output. A high current circuit is coupled to the output of the op-amp. The high current circuit including a transistor having a base, emitter and collector, the base is coupled to the output of the regulated voltage circuit, the emitter is coupled to VCC, and the collector is coupled to the positive input of the op-amp and to the gas sensor heater.

The present invention also provides in one embodiment, an electronic breath analyzer having a gas sensor for alcohol detection. The gas sensor includes a heater and a gas sensing element. A heater circuit is coupled to the gas sensor heater. A resistor ladder is coupled between the gas sensing element and a voltage reference VREF. A pair of comparator circuits include an input and an output, the input is coupled to the gas sensing element, each comparator circuit includes an operational amplifier having a positive input, a negative input and an output, the negative inputs are coupled together and to the gas sensing element. Respective feedback resistors R1, R15 are coupled between the output and the positive input, a resistor R3 is coupled between the positive input of a first of the comparators and the voltage reference VREF, a resistor R11 is coupled between the positive input of a second of the comparators and to the positive input of the first comparator. An indicator circuit is coupled to the output of the pair of comparator circuits.

### BRIEF DESCRIPTION OF DRAWINGS

FIG. 1 shows a block diagram of a breath tester system according to a preferred embodiment of the present invention;

FIG. 2 shows a circuit schematic diagram of a breath tester according to a preferred embodiment of the present invention;

FIG. 3 shows a flow diagram of the steps of calibration of a breath tester according to a preferred embodiment of the present invention; and

FIG. 4 shows a flow diagram of the steps of operation of a breath tester according to a preferred embodiment of the present invention.

### DETAILED DESCRIPTION OF DRAWINGS

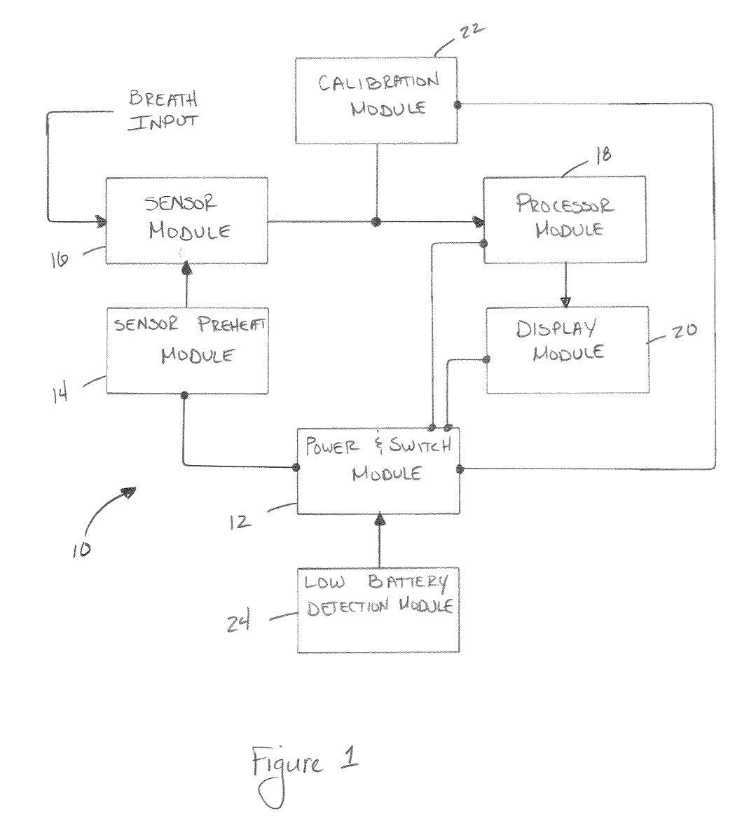

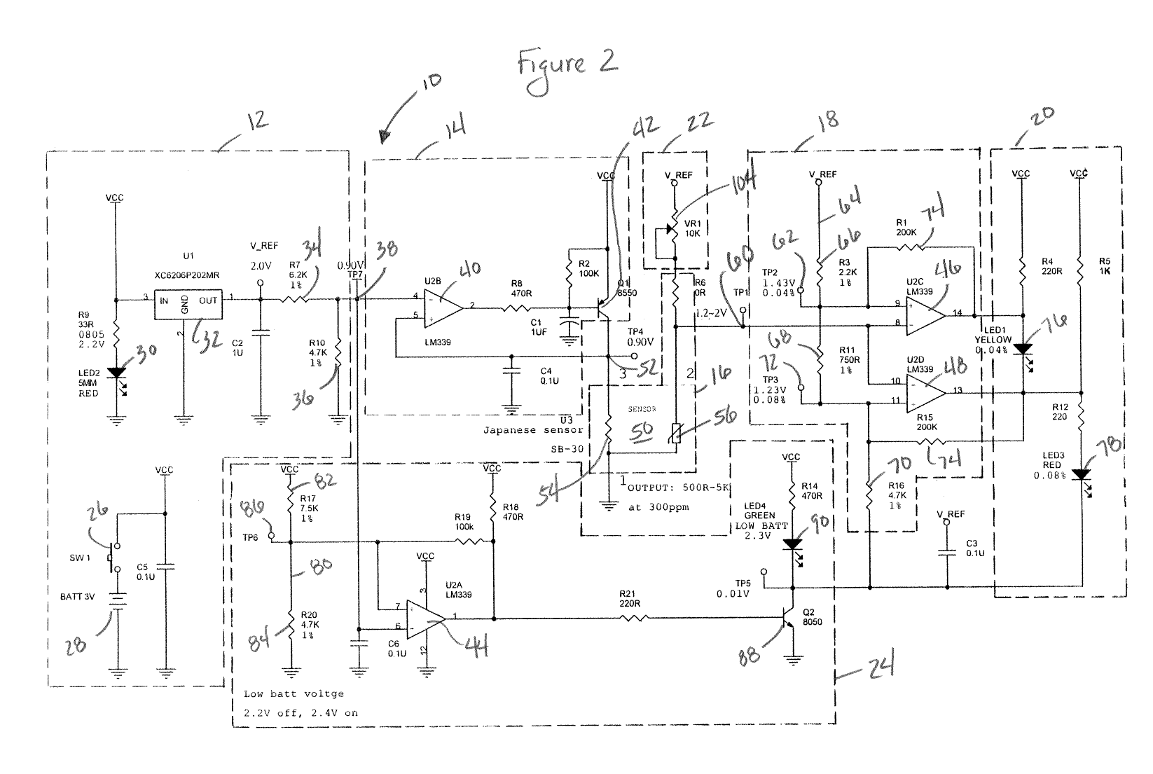

FIGS. 1 and 2 show a breath tester device 10 in accordance with a preferred embodiment of the present invention for testing a breath sample from the user of the device 10 and calculating the blood alcohol content of the breath sample. As is seen in the block diagram of FIG. 1 and the circuit schematic of FIG. 2, the breath tester device 10 comprises the following modules: Power and Switch Module 12; Sensor Preheat Module 14; Sensor Module 16; Processor Module 18; Display Module 20, Calibration Module 22, and Low Battery Detection Module 24. The individual modules have been organized and named for purposes of convenience in describing the structure and arrangement of components in a preferred embodiment and should not be considered as limiting in any manner.

Referring first to the Power and Switch Module 12, depressing switch 26 couples the positive terminal of the power source 28 to the remainder of the circuit to provide voltage to the modules identified above. Preferably, the power source is a 3V battery providing a 3V DC voltage (Vcc) to the circuit. Depressing the switch 26 provides an input voltage to indicator LED 30, illuminating the LED and signaling to the user that the switch 26 has been triggered and the device 10 has power. The power source 26 is also coupled to the input terminal of a positive voltage regulator 32 that steps Vcc down to a predetermined Vref. In the present embodiment of the invention, Vcc is 3V and Vref is 2V. The voltage regulator 32 may be of any type suitable for the intended purpose. In the present invention, the voltage regulator 32 is manufactured by Torex Semiconductor and is sold under Product Number XC6206P202MR. The voltage regulator 32 has an output voltage of 2V with an accuracy of +/−2.0% and a maximum output current of 250 mA.

A resistance ladder formed by resistors 34, 36 will further step down the voltage Vref. In the preferred embodiment of the present invention, resistors 34, 36 are selected to provide a voltage of approximately 0.9V at Test Point #7 38, measured between the resistors 34, 36 of the resistance ladder. As described in detail below, the Sensor Module 16 operates optimally when its input voltage is 0.9V. Accordingly, resistors 34, 36 are selected to have very small tolerance ranges to insure the desired voltage is present at Test Point #7 38.

As is seen in the Sensor Preheat Module 14, Processor Module 18, and Low Battery Detection Module 24, the breath detector 10 of the present invention utilizes operational amplifiers 40, 44, 46, 48 to perform various circuit functions. In the present invention, the preferred op-amp is model number LM339, manufactured and sold by National Semiconductor. The LM339 op-amp comprises four independent voltage comparators designed to operate from a single power supply over a wide range of voltages.

Op-amp 40 of the Sensor Preheat Module 14 is used, in connection with transistor 42, to provide the Sensor Module 16 with a desired voltage and current. The inverting input terminal of op-amp 40 is coupled to Test Point #7. The voltage at Test Point #7 is, in turn, provided as an input voltage to the Sensor Preheat Module 14. The output terminal of op-amp 40 is coupled to the base of transistor 42. The emitter of transistor 42 is coupled to the power source 26 and is provided with Vcc from the power source 26. The non-inverting input terminal of the op-amp 40 and the collector of transistor 42 are both coupled together at Test Point #4 52. In this configuration, the transistor 42 is used to amplify the regulated voltage output of op-amp 40. Accordingly, the voltage at Test Point #4 is regulated and stabilized and has a large current, enabling high current loading (at least 300 mA) of the Sensor Module 16, as will be described below.

In a preferred embodiment of the present invention, the Sensor Module 16 comprises a tin dioxide semiconductor gas sensor 50. Tin dioxide sensors have high sensitivity to the presence of alcohol, however, it is contemplated that other suitable gas sensors are available and can be utilized in the present invention. The sensor 50 comprises a heating element 54 and a sensing element 56. The heating element 54 comprises a resistor having a first end coupled to the voltage output of the Sensor Preheat Module 14 at Test Point #4 52 and a second end coupled to ground. The sensing element 56 comprises a variable resistor having conductivity that varies depending on the temperature of the sensor and the concentration of alcohol vapors present in the breath sample. A tin dioxide gas sensor manufactured by FiS, Inc. of Japan and sold under Product Number SB-30 is utilized in a preferred embodiment of the present invention.

In order to obtain optimum performance from the sensor 50 the voltage applied across the heating element 54 must be regulated and held steady. The sensor 50 of the present invention exhibits optimum performance when a voltage of 0.9V is applied to the heating element 54. As previously described, the components of the Sensor Preheat Module 14 are selected to provide a constant 0.9V with at least 300 mA of current to the heating element during operation of the breath test device 10 of the present invention.

The Sensor Module 16 generates an output voltage at Test Point #1 60 that is processed by the components of the Processor Module 18 to determine the range of blood alcohol content of the breath sample. The voltage at Test Point #1 is coupled to the inverting input terminals of first and second op-amps 46, 48. The non-inverting input terminal of the first op-amp 46 is coupled to Test Point #2 62 on the resistance ladder 64, comprised of resistors 66, 68, and 70. The non-inverting input terminal of the second op-amp 48 is coupled to Test Point #3 72 of the resistance ladder 64. The feedback loops of both the first and second op-amps 46, 48 are coupled to the non-inverting input terminals of the op-amps across high impedance resistors 74. In this configuration, the first and second op-amps 46, 48 are voltage comparators that will switch between saturated fully positive and saturated fully negative states depending on the voltage differential across the inverting and non-inverting input terminals of each op-amp. In the present embodiment, the saturated fully positive state of the first and second op-amps 46, 48 is equal to Vcc (+3V) and the saturated fully negative state is equal to ground (0V).

As is shown, resistors 66, 68 are selected to have small tolerances, in the 1% range, to ensure that voltage at the non-inverting input terminals of the first and second op-amps 46, 48 is accurate. In the preferred embodiment of the present invention, resistor 66 is selected to have a resistance of 2.2 kΩ with a 1% tolerance, resistor 68 is selected to have a resistance of 750Ω with a tolerance of 1%, and resistor 70 is selected to have a resistance of 4.7 kΩ. Accordingly, when Vref to the resistance ladder 64 is at 2.0V, Test Point #2 is at 1.43V (accurate within 0.04%) and Test Point #3 is at 1.23V (accurate within 0.08%).

The Display Module 20 comprises a first and second LED 76, 78 that illuminate in response to voltage output signals received from the comparator circuitry of the Processor Module 18. The first LED 76 is preferably yellow in color and illuminates when the user's blood alcohol level is determined by the Processor Module 18 to be greater than 0.04% but less than 0.08%. The second LED 78 is preferably red in color and illuminates with the user's blood alcohol level is determine by the Processor Module 18 to be at least 0.08%.

Because the resistance of the sensing element 56 of the Sensor Module 16 decreases as the alcohol content of the breath sample increases, the voltage reading at Test Point #1 60 will decrease as the alcohol content of the breath sample increases. When the voltage at Test Point #1 60 is greater than 1.43V, the reference voltage at the inverting input terminals of the first and second op-amps 46 and 48 will be greater than the voltages at the non-inverting input terminals. This results in the first and second op-amps 46 and 48 remaining in their respective saturated fully negative states, providing a 0V output signal. The LEDs 76, 78 will both remain dark.

When the voltage at Test Point #1 is less than 1.43V but greater than 1.23V, the first op-amp 46 will switch to its saturated fully positive state because the voltage at the inverting input terminal will be less than the voltage at the non-inverting input terminal. As a result, a positive voltage output signal of Vcc (+3V) will be place across the yellow LED 76, causing the LED 76 to illuminate. When the voltage at Test Point #1 is less than 1.43V but greater than 1.23V, op-amp 48 will remain in its saturated fully negative state, providing an output of 0V, because the voltage at the inverting terminal is greater than the voltage at the non-inverting terminal. This results in the red LED 78 remaining dark. Illumination of the yellow LED 76 indicates to the user of the device 10 that his or her blood alcohol content is between 0.04% and 0.08%.

When the voltage at Test Point #1 60 is less than 1.23V, the second op-amp 48 will be at its saturated fully positive state because the voltage at the inverting input terminal is less than the voltage at the non-inverting input terminal. As a result, the second op-amp 48 will send a voltage output signal of +3V (Vcc) to the Display Module 20. The positive voltage output signal from the second op-amp 48, result in a positive voltage drop across the red LED 78, illuminating the red LED. Illumination of the red LED 78 when the voltage at Test Point #1 is below the 1.23V threshold indicates to the user of the device 10 that his or her blood alcohol level is above 0.08%. The yellow LED 76 will remain dark when the voltage at Test Point #1 is less than 1.23V because a positive voltage drop across the LED is not present.

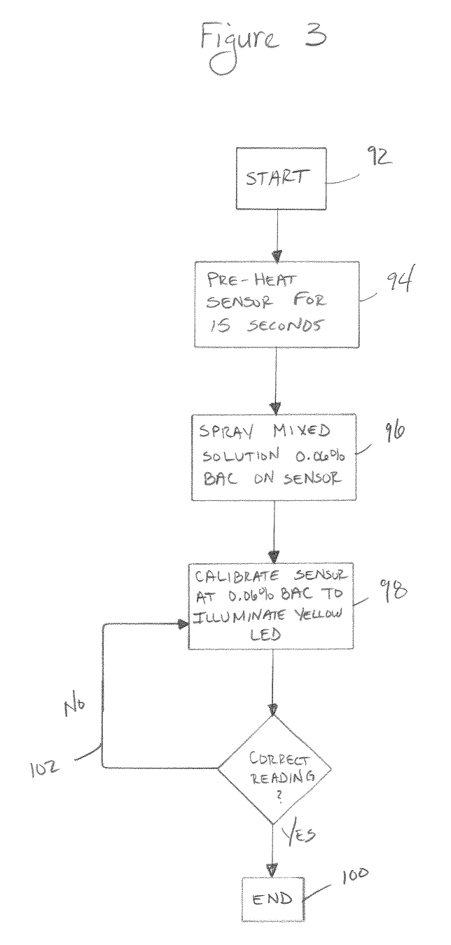

As previously disclosed, the breath tester 10 of the present invention also includes a Calibration Module 22 for calibrating the device. In the present embodiment of the invention, the Calibration Module 22 comprises a variable resistor 104 located adjacent to the load resistor 80 of the sensor 50. FIG. 3 shows a flow chart of one methodology for calibrating the device 10 by exposing the Sensor Module 16 to air samples containing a known percentage of alcohol vapors. Referring to FIGS. 2 and 3, the method is initiated 92 by depressing the switch 26 resulting in the preheating 94 of the sensor 50. The sensor 50 is preheated for 15 seconds to ensure that it is operating optimally. Next, a mixing solution is prepared with distilled water and ethanol to a represent a known blood alcohol content. In the present example, the mixing solution is prepared to represent a 0.06% blood alcohol content and is sprayed 96 on the sensor 50. If the breath tester device is calibrated properly, at a 0.06% blood alcohol content, the yellow LED on the breath tester device should illuminate 98. If the yellow LED illuminates, the device is properly calibrated and the calibration routine ends 100. If the yellow LED remains dark, the device is not properly calibrated 102 and must be recalibrated by adjusting the variable resistor 104 of the Calibration Module 22. To ensure the accuracy of the calibration of the device, this process can be repeated using mixing solutions corresponding to 0.04% and 0.08% blood alcohol content.

The breath tester 10 also includes a Low Battery Detection Module 24. The voltage applied to the inverting input terminal of op-amp 44 as the reference voltage is the voltage measured at Test Point #7 38 and is always at approximately 0.9V. A resistance ladder 80 is comprised of resistors 82, 84 both resistors having a 1% tolerance. The voltage at Test Point #6 86 on the resistance ladder 80 is supplied to the non-inverting input terminal of the op-amp 44. The op-amp 44 also functions as a voltage comparator, similar to the op-amps 46, 48 of the Processor Module 18. In the present embodiment, resistor 82 is selected to have a resistance of 7.5 kΩ (within a tolerance of 1%) and resistor 84 is selected have a resistance of 4.7 kΩ (within a tolerance of 1%). Accordingly, when the voltage Vcc is 3V, the voltage at Test Point #6 is 1.15V; when the voltage Vcc is 2.4V, the voltage at Test Point #6 is 0.92V; and when the voltage Vcc is 2.2V, the voltage at Test Point #6 is 0.84V.

Because the voltage applied to the inverting input terminal of the op-amp 44 is 0.9V, as long as the voltage applied to the non-inverting input terminal of the op-amp 44 is above 0.9V, the op-amp 44 is saturated fully positive and applies a voltage of +3V (Vcc) to the base of transistor 88 (coupled to the output terminal of the op-amp 44). Transistor 88 is configured in the N-P-N configuration with the emitter coupled to ground. When the positive voltage from the output terminal of op-amp 44 is applied to the base of transistor 88, the collector and emitter of the transistor 88 couple together, bringing the collector to ground as well. Grounding the collector enables a voltage (Vcc) to be applied across green LED 90 illuminating the LED and indicating that the power source 28 is providing a sufficient operational voltage to the device 10. Grounding the collector of transistor 88 also has the effect of grounding the Processor Module 18, enabling voltage to be supplied to the Processor Module 18.

When the voltage Test Point #6 86 falls below a threshold voltage, the output of the op-amp 44 will no longer be at Vcc, but will switch to 0V. The transistor 88 will open, uncoupling the collector and emitter. Under these circumstances, voltage will not be applied across the green LED 90 and the green LED 90 will not be illuminated, indicating that the power source 28 has insufficient power to run the device 10. When the collector of the transistor 88 is not grounded, the Processor Module 18 will also not function.

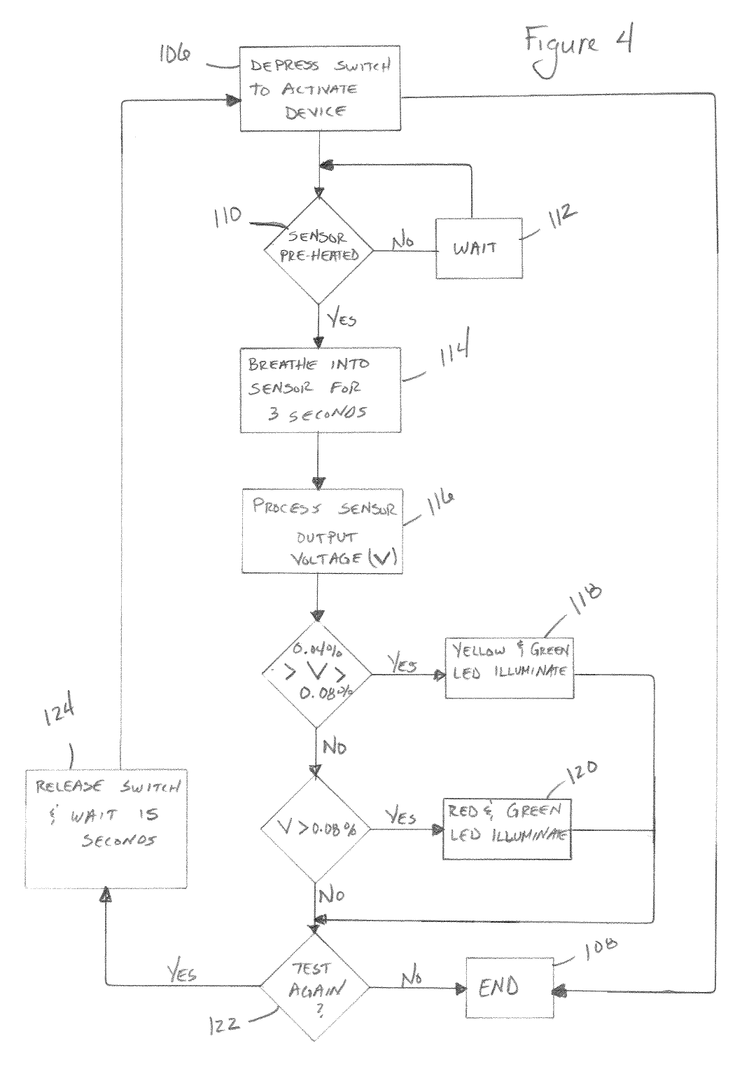

FIG. 4 shows a flow diagram of the breath tester of the preferred embodiment in operation. Referring to FIGS. 2 and 4, in operation, the user will first 106, depress the switch 26 to activate the breath tester device 10. This results in the device first testing the power source 28 with the Low Batter Detection circuitry 24 to determine if the power source 28 has adequate power for powering the device 10. If no, device will not operate 108. If yes, the green LED 90 will illuminate and voltage Vcc is provided to the input of the step-down voltage converter 32 and applied across resistors 34, 36 to provide the desired voltage at Test Point #7 38. The Test Point #7 voltage and voltage Vcc are input voltages to the Sensor Preheat Module 14. The Sensor Preheat Module 14 provides the Sensor Module 16 with predetermined voltage and current to enable optimum performance of the Sensor Module 16. The Sensor Module 16 requires preheating for a period of 6 to 14 seconds, depending on the last time the device was used. While the Sensor Module 16 is preheating and the user is waiting to use the device 10, the green LED 90, yellow LED 76, and red LED 78 will be illuminated 112. Once the sensor 50 is preheated, the yellow LED 76 and red LED 78 will go dark and the user provides a breath sample to the sensor 50 of the Sensor Module 16 by breathing into the sensor 50 for a period of 3 seconds 114.

Next 118, the Sensor Module 16 provides the Processor Module 18 with an output voltage reflecting the change in resistance of the sensing element 56 resulting from exposure to alcohol vapor in the breath sample. The output voltage from the Sensor Module 18 is compared to known reference voltages by the comparator circuitry of the Processor Module 18.

When the output voltage from the Sensor Module 16 corresponds to a blood alcohol content of between 0.04% and 0.08%, the yellow LED 76 will be illuminated 118 (the green LED 90 also remains illuminated to indicate that the device 10 is functioning properly). When the output voltage from the Sensor Module 16 corresponds to a blood alcohol content of above 0.08%, the red LED 78 will be illuminated 120 (the green LED 90 also remains illuminated to indicate that the device 10 is functioning properly). When the output voltage from the Sensor Module 16 corresponds to a blood alcohol content of less than 0.04%, only the green LED 90 is illuminated, the yellow LED 76 and red LED 78 remain dark. If the user desires to take another reading 122, the user will release the switch 26 and wait 15 seconds before following the procedure outlined above again 124. Otherwise, the process will end 108.

The foregoing description of an exemplary embodiment has been presented for purposes of illustration and description. It is not limited to be exhaustive nor to limit the invention to the precise form disclosed. Obvious modifications or variations are possible in light of the above teachings. The embodiment described herein best illustrates the principles of the invention and its practical application to thereby enable one of ordinary skill in the art to best utilize the invention in various embodiments and with various modifications as are suited to the particular use contemplated. It is intended that the scope of the invention be defined by the claims appended hereto.

We claim:

1. An electronic breath analyzer comprising:
a gas sensor for alcohol detection, the gas sensor having a heater and a gas sensing element;
a regulated voltage circuit having an operation amplifier, the op-amp having a negative input coupled to the voltage source, a positive input and an output;
a high current circuit coupled to the output of the op-amp, the high current circuit including a transistor having a base, emitter and collector, the base is coupled to the output of the regulated voltage circuit, the emitter is coupled to VCC, and the collector is coupled to the positive input of the op-amp and to the gas sensor heater.

2. The electronic breath analyzer of claim 1, wherein resistor R8 is coupled between the output of the op-amp and the base of the transistor, a resistor R2 is coupled between the base and emitter of the transistor, a capacitor C1 is coupled between the base of the transistor and ground, and a capacitor C4 is coupled between the gas sensor heater and ground.

3. The electronic breath analyzer of claim 2, wherein resistor R8 is 470 ohms, resistor R2 is 100 K ohms, capacitor C1 is 1 microfarad and capacitor C4 is 0.1 microfarads.

4. The electronic breath analyzer of claim 2, wherein a resistor ladder is coupled between the gas sensing element and a reference voltage VREF, the resistor ladder including resistor R6 coupled to the gas sensing element and a potentiometer VR1 coupled to the voltage reference VREF.

5. The electronic breath analyzer of claim 4, wherein potentiometer VR1 is 10 K ohms and resistor R6 is 0 ohms.

6. The electronic breath analyzer of claim 2, further comprising a pair of comparator circuits having an input and an output, a comparator reference voltage is coupled to each comparator circuit, the input is coupled to the gas sensing element and the output is coupled to an indicator circuit.

7. The electronic breath analyzer of claim 5, wherein the indicator circuit includes an LED associated with each comparator circuit.

8. The electronic breath analyzer of claim 2, further comprising a pair of comparator circuits having an input and an output, the input is coupled to the gas sensing element, each comparator circuit includes an operational amplifier having a positive input, a negative input and an output, the negative inputs are coupled together and to the gas sensing element, respective feedback resistors R1, R15 are coupled between the output and the positive input, a resistor R3 is coupled between the positive input of a first of the comparators and the voltage reference VREF, a resistor R11 is coupled between the positive input of a second of the comparators and to the positive input of the first comparator.

9. An electronic breath analyzer comprising:
a gas sensor for alcohol detection, the gas sensor having a heater and a gas sensing element;
a heater circuit coupled to the gas sensor heater;
a resistor ladder coupled between the gas sensing element and a voltage reference VREF;
a pair of comparator circuits having an input and an output, the input is coupled to the gas sensing element, each comparator circuit includes an operational amplifier having a positive input, a negative input and an output, the negative inputs are coupled together and to the gas sensing element, respective feedback resistors R1, R15 are coupled between the output and the positive input, a resistor R3 is coupled between the positive input of a first of the comparators and the voltage reference VREF, a resistor R11 is coupled between the positive input of a second of the comparators and to the positive input of the first comparator; and
an indicator circuit coupled to the output of the pair of comparator circuits.

10. The electronic breath analyzer of claim 9, wherein resistors R3, R11 and R16 are 2.2 K ohms, 750 ohms, and 4.7 K ohms, respectively, and have a 1 percent tolerance.

11. The electronic breath analyzer of claim 9, wherein feedback resistors R1 and R15 are each 200 K ohms.

12. The electronic breath analyzer of claim 9, wherein the indicator circuit includes a light emitting diode LED1 coupled between the comparator outputs, a resistor R4 coupled between the output of the first comparator and voltage VCC, a light emitting diode LED3 and resistor R12 coupled between the output of the second comparator and ground, a resistor R5 coupled between the output of the second comparator and voltage VCC.

13. The electronic breath analyzer of claim 12, wherein resistors R4 and R12 are each 220 ohms and resistor R5 is 1 K ohms.
